(19) United States
(12) Patent Application Publication
(10) Pub. No.: US 2015/0129003 A1
(43) Pub. Date: May 14, 2015

(54) Coffee Brewer Nozzle Cleaning Device

(71) Applicant: Uni-Splendor Corp., Tainan (TW)

(72) Inventor: Yu-Yuan Lin, Tainan (TW)

(21) Appl. No.: 14/079,431

(22) Filed: Nov. 13, 2013

(51) Int. Cl. A47J 31/60

(52) U.S. Cl. CPC A47J 31/60
USPC 134/166 C

(57) ABSTRACT

A coffee brewer nozzle cleaning device for rinsing a water outlet needle disposed in a coffee brewer whenever the water outlet needle is clogged is characterized in that: a rinsing device holding therein water is put in a water outlet cavity in the coffee brewer; and a hand presses an upper base of the coffee brewer repeatedly, so as for the water outlet needle to suck and eject the water of the rinsing device back and forth, thereby eliminating internal congestion as expected.

### BACKGROUND OF THE INVENTION

1. Technical Field

The present invention relates to a coffee brewer nozzle cleaning device for rinsing a water outlet needle disposed in a coffee brewer whenever the water outlet needle is clogged. The coffee brewer nozzle cleaning device of the present invention is characterized in that: a rinsing device which holds therein water is put in a water outlet cavity in the coffee brewer; and a user's hand presses an upper base of the coffee brewer repeatedly, so as for the water outlet needle to suck and eject the water of the rinsing device back and forth, thereby eliminating internal congestion as expected.

2. Description of Related Art

After conventional coffee brewers for brewing coffee manually and immediately before drinking have been operating for a while, and then boiled water is instantaneously poured into a containing space which holds a powdered coffee raw material, a water outlet needle from which the boiled water is gradually discharged is likely to get clogged. To unclog the water outlet needle, a user usually inserts a fine needlelike object into the water outlet needle to clean the periphery thereof, or replaces the clogged water outlet needle with a new water outlet needle.

Although the aforesaid two conventional ways of unclogging a water outlet needle in a coffee brewer do serve their purpose, the present invention hereby puts forth a more convenient solution of unclogging a water outlet needle with a view to cutting the costs incurred in changing the water outlet needle.

### BRIEF SUMMARY OF THE INVENTION

The present invention aims to improve on a conventional way of rinsing a water outlet needle disposed in a coffee brewer whenever the water outlet needle is clogged. The present invention is characterized in that: a rinsing device which holds therein water is put in a water outlet cavity in the coffee brewer; and a user's hand presses an upper base of the coffee brewer repeatedly, so as for the clogged water outlet needle to suck and eject the water of the rinsing device back and forth, thereby eliminating internal congestion as expected.

The first objective of the present invention is to provide a rinsing device for rinsing a water outlet needle disposed in a coffee brewer whenever the water outlet needle is clogged. The rinsing device comprises a rinsing element and a ring. A water inlet of an appropriate diameter is disposed at an upper end of the rinsing element, and a periphery of the rinsing element extends to form a flange positioned proximate to a predetermined height, such that the ring which has a hollow-out region centrally disposed therein abuts against a lower end of the flange of the rinsing element, so as to assemble the rinsing device. The rinsing device is adapted to remove clogs from the water outlet needle of the coffee brewer and operated by a user following the steps of: pouring water into the rinsing element of the rinsing device; putting the rinsing device in a water outlet cavity of the coffee brewer; and using the hand to press the upper base of the coffee brewer repeatedly, so as for the water outlet needle to suck and eject the water of the rinsing device back and forth, thereby removing clogs from the water outlet needle.

The second objective of the present invention is that, although the ring is coupled to the rinsing element to form the rinsing device collectively, it is also feasible to dispense with the ring such that, after water has been poured into the rinsing element in the rinsing device, the hand grips the rinsing element in a manner to enable the rinsing element to correspond in position the water outlet needle of the coffee brewer and presses the rinsing element repeatedly, so as for the water outlet needle to suck and eject the water of the rinsing element back and forth, thereby removing clogs from the water outlet needle.

The third objective of the present invention is that the rinsing element of the rinsing device comprising the ring and the rinsing element coupled thereto is made of a silicone with appropriate resilience.

### BRIEF DESCRIPTION OF THE SEVERAL VIEWS OF THE DRAWINGS

FIG. 1 is an exploded view of a nozzle rinsing device according to the present invention;

FIG. 2 is a perspective view of the nozzle rinsing device assembled according to the present invention;

FIG. 3 is a schematic view of the nozzle rinsing device which holds water according to the present invention;

FIG. 4 is a schematic view of the nozzle rinsing device which holds water but has not been put into a coffee brewer according to the present invention;

FIG. 5 is a schematic view of the nozzle rinsing device which holds water and has been put into a coffee brewer according to the present invention;

FIG. 6 is a schematic view of the nozzle rinsing device positioned in the coffee brewer according to the present invention, showing a user pressing an upper base repeatedly;

FIG. 7 is another schematic view of the nozzle rinsing device positioned in the coffee brewer according to the present invention, showing the user pressing the upper base repeatedly; and

FIG. 8 is a schematic view of the nozzle rinsing device which holds water according to the present invention, showing how to rinse a water outlet needle of the nozzle rinsing device.

### DETAILED DESCRIPTION OF THE INVENTION

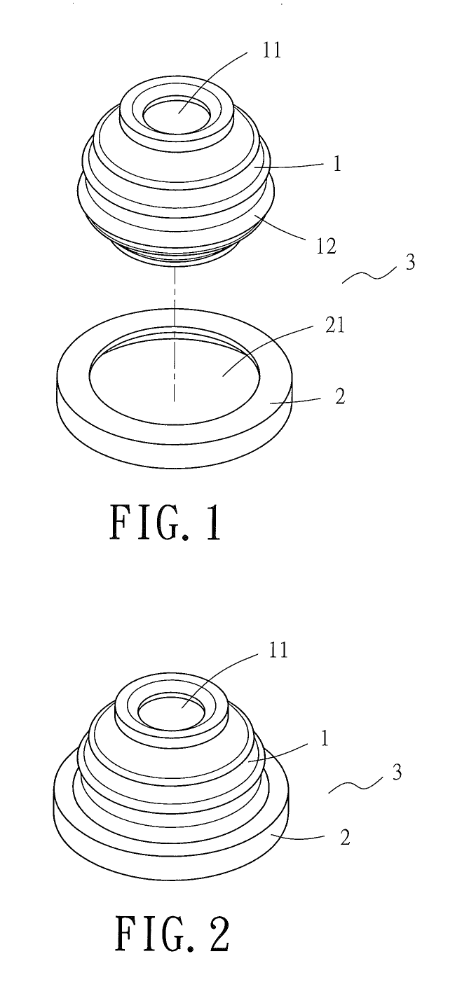

Referring to FIG. 1, a coffee brewer nozzle cleaning device of the present invention is provided in the form of a rinsing device 3 for rinsing a water outlet needle disposed in a coffee brewer whenever the water outlet needle is clogged. The rinsing device 3 comprises a rinsing element 1 and a ring 2.

The rinsing element 1 is a hollow-core containing element characterized by a predetermined shape and integrally formed out of a silicone with appropriate resilience. A water inlet 11 of an appropriate diameter is disposed at the upper end of the rinsing element 1. The periphery of the rinsing element 1 extends to form a flange 12 positioned proximate to a predetermined height.

The ring 2 is a hollow-core supporting element corresponding in shape to the outer rim of the rinsing element 1. A hollow-out region 21 is centrally disposed in the ring 2 and matches the bottom of the flange 12 of the rinsing element 1 in terms of size in a manner to enable the ring 2 to have a substantially [symbol] -shaped cross-section.

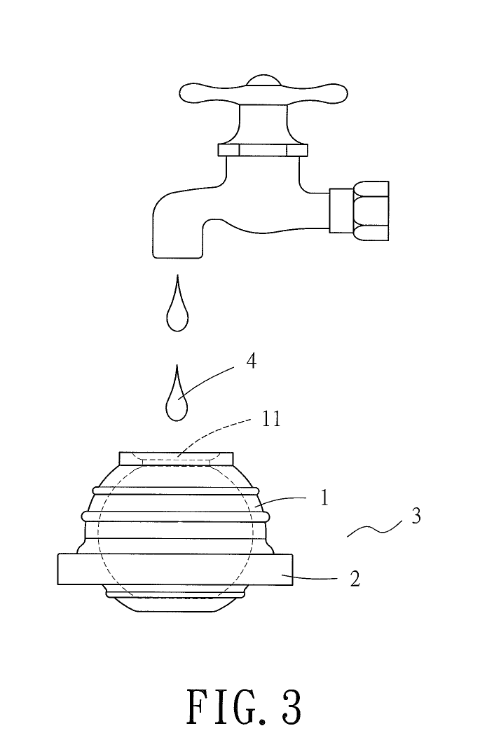

Referring to FIG. 1 and FIG. 2, the process of putting the rinsing element 1 and the ring 2 together entails steps as follows: the hollow-out region 21 centrally disposed in the ring 2 is aimed at the flange 12 extended from the rinsing element 1 and positioned proximate to a predetermined height; and then the hollow-out region 21 centrally disposed in the ring 2 is pushed upward until it abuts against the lower end of the flange 12 of the rinsing element 1, so as to assemble the rinsing device 3, as shown in FIG. 3.

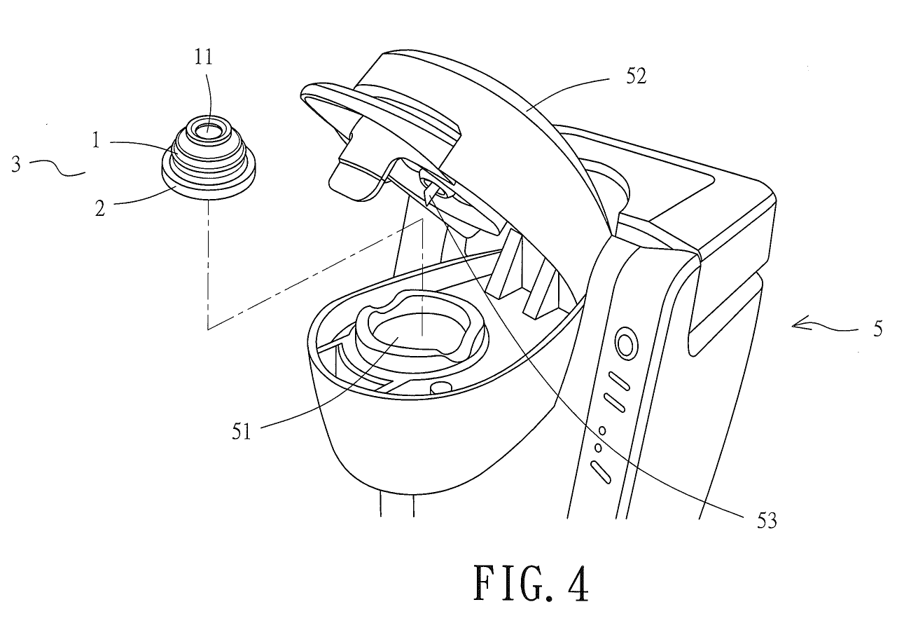

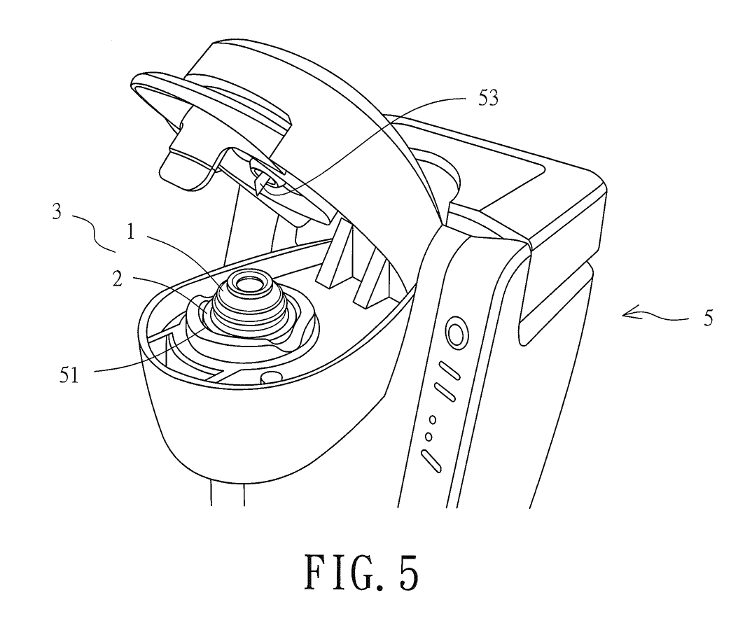

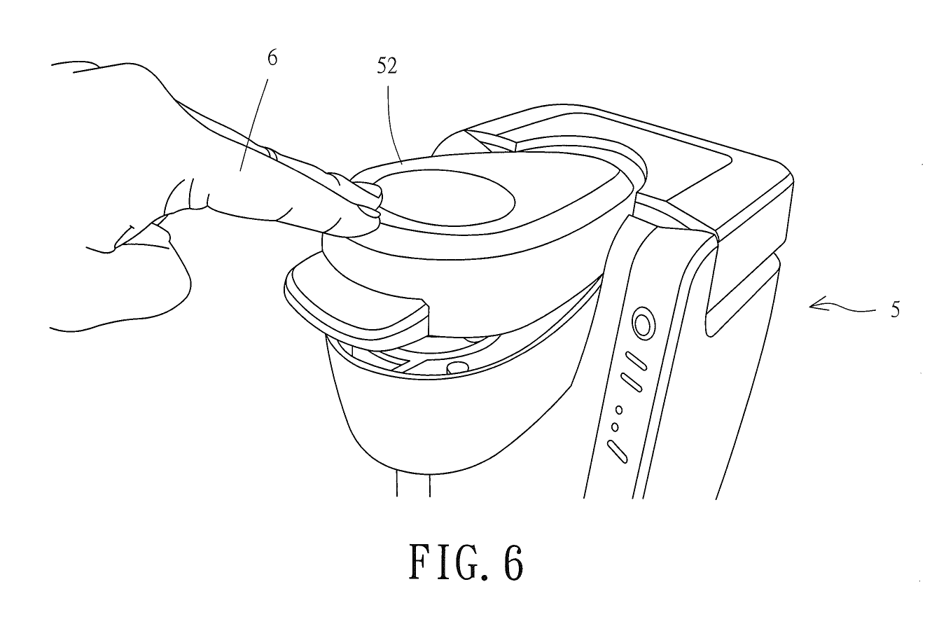

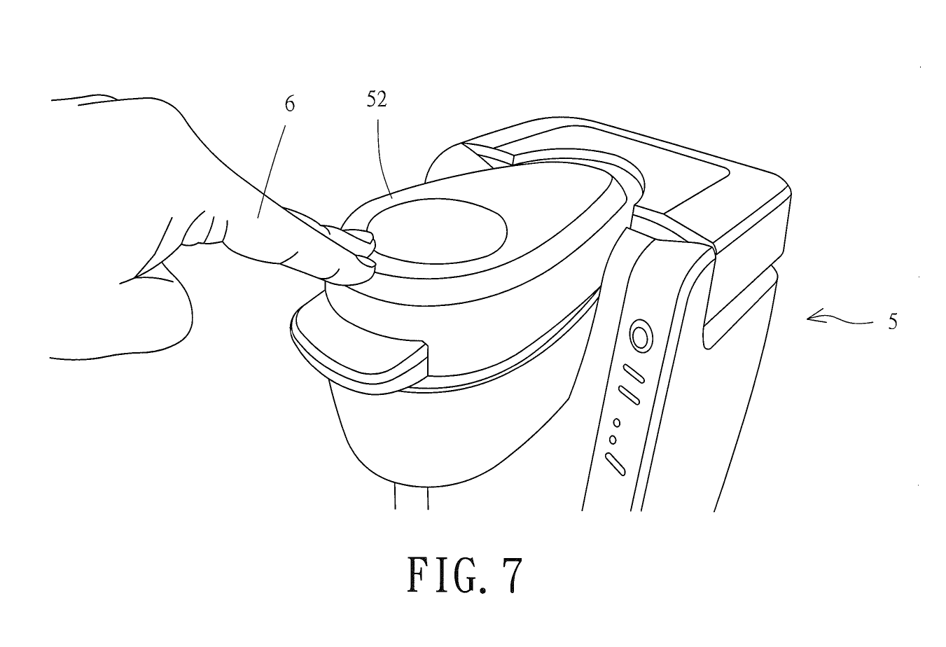

Referring to FIG. 3, the process of removing clogs from the water outlet needle of the coffee brewer by means of the rinsing device 3 entails steps as follows: pour water 4 into the rinsing element 1 in the rinsing device 3; put the rinsing device 3 in a water outlet cavity 51 of a coffee brewer 5 as shown in FIG. 4 and FIG. 5; press, with a hand 6, an upper base 52 of the coffee brewer 5 repeatedly as shown in FIG. 6 and FIG. 7; and insert/withdraw a water outlet needle 53 into/from the rinsing element 1 of the rinsing device 3, so as for the water outlet needle 53 to suck and eject the water of the rinsing device 3 back and forth, thereby removing clogs from the water outlet needle 53.

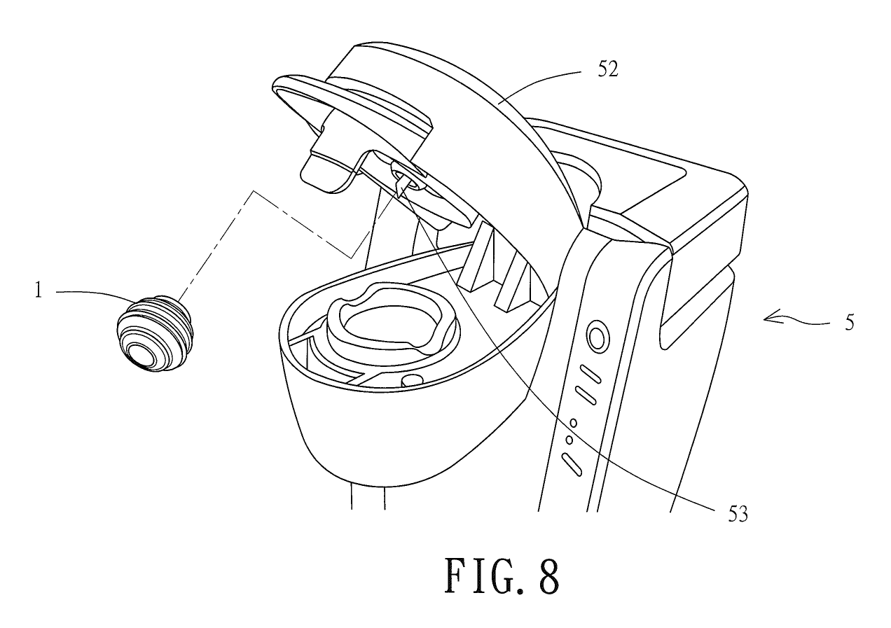

Although in the above embodiment the ring 2 is coupled to the rinsing element 1 to form the rinsing device 3 collectively, it is also feasible to dispense with the ring 2 in a variant embodiment shown in FIG. 8. In the variant embodiment, after water has been poured into the rinsing element 1 in the rinsing device 3, the hand grips the rinsing element 1 in a manner to enable the rinsing element 1 to correspond in position the water outlet needle 53 of the coffee brewer 5 and presses the rinsing element 1 repeatedly, so as for the water outlet needle 53 to suck and eject the water of the rinsing element 1 back and forth, thereby removing clogs from the water outlet needle 53.

What is claimed is:

1. A coffee brewer nozzle cleaning device, being a rinsing device for rinsing a water outlet needle disposed in a coffee brewer whenever the water outlet needle is clogged, comprising:
a rinsing element; and
a ring,
wherein a water inlet of an appropriate diameter is disposed at an upper end of the rinsing element, and a periphery of the rinsing element extends to form a flange positioned proximate to a predetermined height, such that the ring which has a hollow-out region centrally disposed therein abuts against a lower end of the flange of the rinsing element, so as to assemble the rinsing device,
wherein a process of removing clogs from the water outlet needle of the coffee brewer by means of the rinsing device comprises the steps of: pouring water into the rinsing element in the rinsing device; putting the rinsing device in a water outlet cavity of the coffee brewer; and pressing, with a hand, an upper base of the coffee brewer repeatedly, so as for the water outlet needle to suck and eject the water of the rinsing device back and forth, thereby removing clogs from the water outlet needle.

2. The coffee brewer nozzle cleaning device of claim 1, wherein, although the ring is coupled to the rinsing element to form the rinsing device collectively, it is also feasible to dispense with the ring such that, after water has been poured into the rinsing element in the rinsing device, the hand grips the rinsing element in a manner to enable the rinsing element to correspond in position the water outlet needle of the coffee brewer and presses the rinsing element repeatedly, so as for the water outlet needle to suck and eject the water of the rinsing element back and forth, thereby removing clogs from the water outlet needle.

3. The coffee brewer nozzle cleaning device of claim 1, wherein the rinsing element of the rinsing device comprising the ring and the rinsing element coupled thereto is made of a silicone with appropriate resilience.
